(19) United States
(12) Patent Application Publication
(10) Pub. No.: US 2012/0310855 A1
(43) Pub. Date: Dec. 6, 2012

(54) SYSTEMS AND METHODS FOR DETERMINING A SITE FOR AN ENERGY CONVERSION DEVICE

(75) Inventors: Jacklin A. Adams, New Hill, NC (US); Ralph P. Williams, Danville, CA (US)

(73) Assignee: INTERNATIONAL BUSINESS MACHINES CORPORATION, Armonk, NY (US)

(21) Appl. No.: 13/154,087

(22) Filed: Jun. 6, 2011

(51) Int. Cl. G06Q 10/00; G06Q 40/00

(52) U.S. Cl. 705/36 R; 705/1.1

(57) ABSTRACT

Systems, methods and computer program products provide for determining the location of an energy conversion device to convert renewable energy into electrical energy. A method for determining the location of a renewable energy conversion device, via a data processing system, includes displaying a qualified site to establish the conversion device within a user-identified geographic area and calculating the potential energy production of the conversion device at the qualified site. The method further includes calculating the cost expenditure to construct the conversion device at the qualified site, the cost expenditure including at least construction contractor labor rates and material costs that are collected from construction contractors located within the geographic area. The method also further includes displaying for selection by the user at least one public or private funding source to establish the conversion device at the qualified site and submitting a funding-source application in response to a user selection of the funding source.

### BACKGROUND

The present invention relates to generally to systems and methods for determining a site to establish a renewable energy conversion device. More specifically, the present invention relates to systems and methods for determining a site to establish a conversion device for converting renewable energy into electrical energy within a user-identified geographic area.

### BRIEF SUMMARY

According to one embodiment of the present invention, a method for determining the location of a conversion device for converting renewable energy into electrical energy, via a data processing system, may include displaying a qualified site to establish the conversion device within a user-identified geographic area and calculating the potential energy production of the conversion device at the qualified site. The method may further include calculating the cost expenditure to construct the conversion device at the qualified site, the cost expenditure including at least construction contractor labor rates and material costs that are collected from construction contractors located within the geographic area, displaying for selection by the user at least one public or private funding source to establish the conversion device at the qualified site and submitting a funding-source application in response to a user selection of the funding source. Some embodiments of the method may further include displaying for user selection at least one construction contractor within the geographic area and accepting a user-selected construction contractor.

One or more embodiments of the method may also include contacting a construction contractor in response to the user selection of the construction contractor. An embodiment of the method may also include calculating a projected return of investment of the conversion device at the qualified site. An embodiment of the method may further include displaying more than one qualified site for establishment of a conversion device within a geographic area identified by a user and accepting selection of the qualified site by the user. An embodiment of the method may further include requesting data from the user for the funding source application and inputting the requested data in the funding source application. An embodiment of the method may also include requesting data from the user for the funding source application and inputting the requested data in the funding source application. An embodiment of the method may further include accepting a user-selected funding source.

In another embodiment of the present invention, a computer program product for determining the location of a conversion device for converting renewable energy into electrical energy, may include at least one computer readable storage medium having computer readable program code embodied therewith, the computer readable program code, when read by a processor, may be configured to display a qualified site to establish the conversion device within a user-identified geographic area, calculate the potential energy production of the conversion device at the qualified site and calculate the cost expenditure to construct the conversion device at the qualified site, the cost expenditure for construction including at least construction contractor labor rates and material costs collected from construction contractors within the geographic area. The computer readable program code may be further configured to display for user selection at least one public or private funding source to establish the conversion device at the qualified site and submit a funding-source application in response to a user selection of the funding source.

In yet another embodiment of the present invention, a computer system may include a processor, a memory and a program for determining the location of a conversion device to convert renewable energy into electrical energy. The program may include a plurality of instructions stored in the memory that are executed by the processor to display a qualified site to establish the conversion device within a user-identified geographic area, calculate the potential energy production of the conversion device at the qualified site and calculate the cost expenditure to construct the conversion device at the qualified site, the cost expenditure for construction including at least construction contractor labor rates and material costs collected from construction contractors within the geographic area. The plurality of instructions may further include instructions that are executed by the processor to display at least one public or private funding source to establish the conversion device at the qualified site and submit a funding-source application in response to a user selection of the funding source.

### BRIEF DESCRIPTION OF THE SEVERAL VIEWS OF THE DRAWINGS

FIG. 1 is a pictorial representation of an example of a computer system in which illustrative embodiments may be implemented.

FIG. 2 is a block diagram of an example of a computer in which illustrative embodiments may be implemented.

FIG. 3 is an example of a method for determining the location of a conversion device to convert renewable energy into electrical energy, via a data processing system.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF cable, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

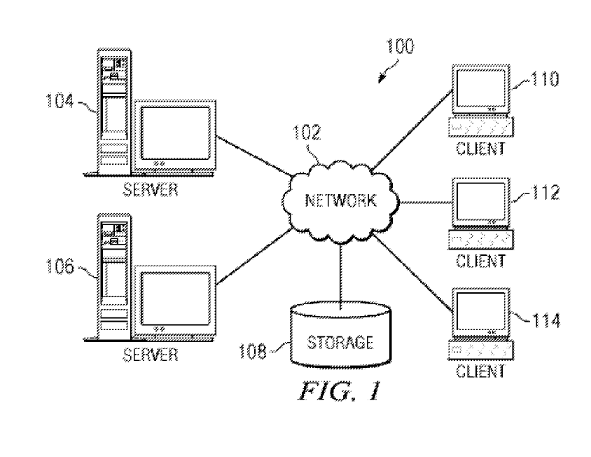

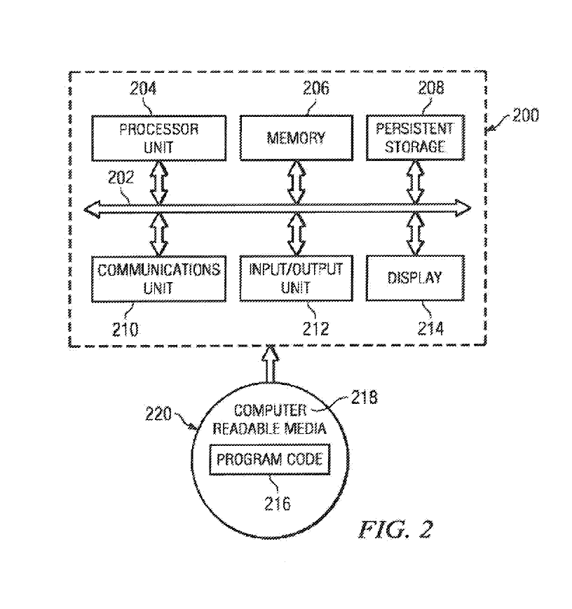

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a computer system, indicated generally at 100, and including a network of computers in which illustrative embodiments may be implemented. Computer system 100 may contain a network 102, which is the medium used to provide communications links between various devices and computers connected together within computer system 100. Network 102 may include connections, such as wire, wireless communication links, or fiber optic cables.

In the depicted example, a server 104 and a server 106 may connect to network 102 along with a storage unit 108. In addition, a first client computer 110, a second client computer 112, and a third client computer 114 may connect to network 102. Client computers 110, 112, and 114 may be, for example, personal computers or network computers. In the depicted example, server 104 may provide data, such as boot files, operating system images, and/or software applications to client computers 110, 112, and 114. Client computers 110, 112, and 114 are clients to server 104 in this example. Computer system 100 may include additional servers, clients, and other devices not shown, or may include fewer devices than those shown.

In the depicted example, network 102 may be or may include the Internet. Computer system 100 also may be implemented with a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client computer 110 in FIG. 1, in which computer-usable program code or instructions implementing the processes may be located for the illustrative embodiments. In this illustrative example, data processing system 200 includes communications fabric 202, which provides communications between a processor unit 204, a memory 206, a persistent storage 208, a communications unit 210, an input/output (I/O) unit 212, and display 214. In other examples, a data processing system may include more or fewer devices.

Processor unit 204 may serve to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices. A storage device is any piece of hardware that is capable of storing information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. For example, communications unit 210 may be a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 may display information to a user.

Instructions for the operating system and applications or programs may be located on persistent storage 208. These instructions may be loaded into memory 206 for execution by processor unit 204. The processes of the different embodiments may be performed by processor unit 204 using computer implemented instructions, which may be located in a memory, such as memory 206. These instructions may be referred to as program code, computer-usable program code, or computer-readable program code that may be read and executed by a processor in processor unit 204. The program code in the different embodiments may be embodied on different physical or tangible computer-readable media, such as memory 206 or persistent storage 208.

Program code 216 may be located in a functional form on a computer-readable media 218 that is selectively removable and may be loaded onto or transferred to data processing system 200 for execution by processor unit 204. Program code 216 and computer-readable media 218 form computer program product 220 in these examples. In one example, computer-readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer-readable media 218 also may take the form of a persistent storage, such as a hard drive, a thumb drive, or a flash memory that is connected to data processing system 200. The tangible form of computer-readable media 218 is also referred to as computer-recordable storage media. In some instances, computer-recordable media 218 may not be removable.

Alternatively, program code 216 may be transferred to data processing system 200 from computer-readable media 218 through a communications link to communications unit 210 and/or through a connection to input/output unit 212. The communications link and/or the connection may be physical or wireless in the illustrative examples. The computer-readable media also may take the form of non-tangible media, such as communications links or wireless transmissions containing the program code. The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown. As one example, a storage device in data processing system 200 is any hardware apparatus that may store data. Memory 206, persistent storage 208, and computer-readable media 218 are examples of storage devices in tangible forms.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that maybe present in communications fabric 202.

Turning now to a method for determining the location of a conversion device for converting renewable energy into electrical energy, certain background and explanatory information is provided to better understand the method. A conversion device for converting a renewable energy into electrical energy may include any conversion device known to those skilled in the art, non-limiting examples of which include, but are not limited to, a wind turbine or a solar panel. Renewable energy may be derived from sunlight, wind, water movement, tides, plant growth, geothermal heat and/or other phenomena that are replenished, for example, naturally replenished resources.

The systems and methods of the present invention are for determining the location of a conversion device for converting renewable energy into electrical energy, and an example would be a system and method for determining the location of a solar farm. Some embodiments of the invention may identify for a user via display 214, and/or store in memory 206, information regarding qualified sites to establish the conversion device within a user-identified geographic area. The user-identified geographic area may include one or more of a street address, city, state, country, zip code and/or a longitude and latitude entered by the user. The user-identified geographic area may further include an area surrounding or adjacent to the address and/or longitude and latitude.

More than one qualified site may be identified within the geographic area. A qualified site may, for example, include tracts of barren or unused land. The qualified site(s) within the user-identified geographic area may be displayed to the user on display 214, for example on a Graphical User Interface (GUI). The user may select one or more of the qualified sites provided, for example by using radial buttons the GUI.

Additionally and/or alternatively, a qualified site may include any other site identified by a qualified user to be a qualified site. The qualified user may be a private or public entity, and the public entity may be a federal, state, county, city, or other government entity. The qualified user may also be required to answer verification questions.

The potential energy production that the user-selected qualified site could achieve as a producer of alternative energy is calculated, for example by using the longitude and latitude coordinates of the qualified site, identifying the climatology alternative energy for the qualified site, and/or determining the amount of kWh that can be retained in the square footage of the qualified site. The information regarding one or more of the longitude and latitude coordinates, the climatology alternative energy, the square footage of the qualified site, and the amount of kWh that can be retained in the square footage may be stored in memory 206, calculated and/or accessed via an internet network.

Additionally and/or alternatively, the cost expenditure to construct the conversion device at the qualified site may be calculated. The cost expenditure may include one or more of the construction contractor labor rates and material costs that may be collected from construction contractors located within the geographic area, the cost of acquiring the land may be any other cost associated with construction of the conversion device at the qualified site.

Available funding sources may be identified and may include, but are not limited to, public or private ones, such as local, state, industrial and academic grants or low interest loans. Those funding sources are used to convert the properties into renewable energy sites. The user may select one or more of the public or private funding sources provided, for example by using radial buttons on the GUI. Additionally and/or alternatively, the rate of return of investment (ROI) in the property may be determined.

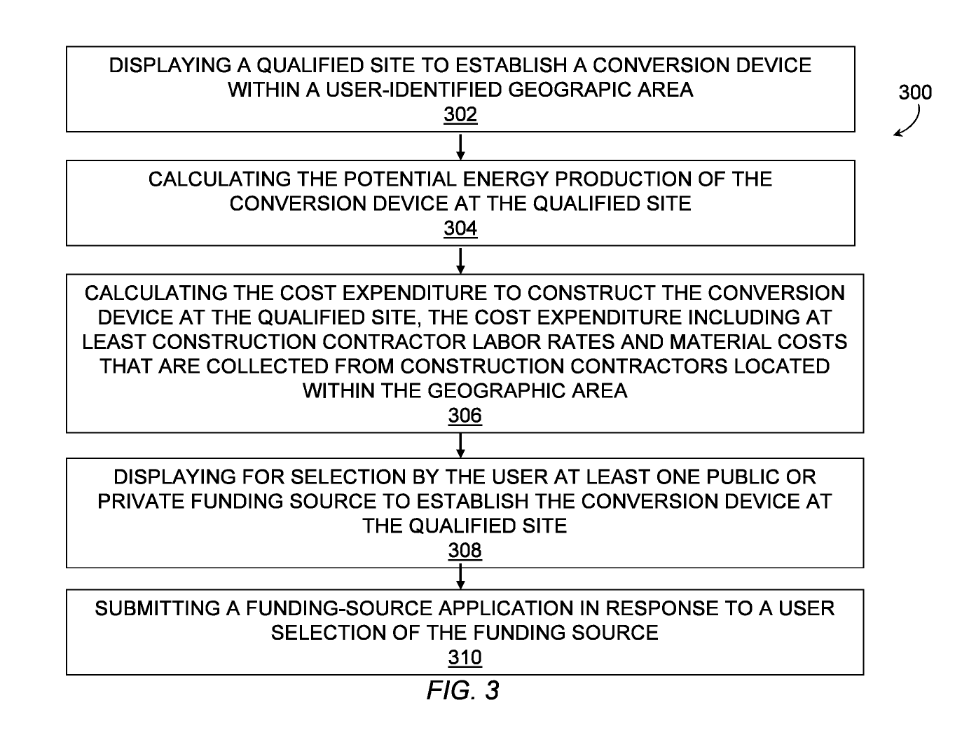

Referring now to FIG. 3, an example of a method for determining the location of a conversion device for converting renewable energy into electrical energy, via a data processing system, is shown. While FIG. 3 shows exemplary steps of a method according to one embodiment, other embodiments may omit, add to, and/or modify any of the steps shown in that figure. In step 302, a qualified site to establish the conversion device within a user-identified geographic area may be displayed. In step 304, the potential energy production of the conversion device at the qualified site may be calculated. In step 306, the cost expenditure to construct the conversion device at the qualified site may be calculated. The cost expenditure may include at least construction contractor labor rates and material costs, one or both of which may be collected from construction contractors located within the geographic area. In step 308, at least one public or private funding source to establish the conversion device at the qualified site may be displayed for selection by the user. In step 310, a funding-source application may be submitted in response to a user selection of the funding source.

Method 300 may include other steps. For example, some embodiments of method 300 may include displaying for user selection at least one construction contractor within the geographic area and accepting a user-selected construction contractor. Some embodiments of method 300 may also include contacting the construction contractor in response to the user selection of the construction contractor.

Furthermore, some embodiments of method 300 may include calculating a projected return of investment of the conversion device at the qualified site. Some embodiments of method 300 may further include displaying more than one qualified site to establish a conversion device within a geographic area identified by a user and accepting selection of the qualified site by the user. Additionally and/or alternatively, some embodiments of method 300 may include requesting data from the user for the funding-source application and inputting the requested data in the funding source application. Also, some embodiments of method 300 may also include accepting from an authorized user a new qualified site to establish a conversion device and storing the new qualified site. Further, some embodiments of method 300 may include accepting a user-selected funding source.

One or more embodiments of the present invention may supply and execute for the user:
Real-time business case for determining the location of a conversion device for converting renewable energy into electrical energy;
Information regarding available grants/credits and/or filled-out forms or retained forms that may be submitted to processing agencies;
Automated notification to contractors for material and permit applications; and/or
Automated data collection for subsequent fund and grant analysis and collection.

Additionally and/or alternatively, some embodiments of the invention may include a method and/or system to develop a database, such as a common IT electronics commodity/industry materials database. The database may be maintained by an individual and/or a private or public organization and may collect funds via advertisement dollars. Information may be inputted and/or collected from one or more sources including, but not limited to, raw material suppliers, users of raw material or compounders, single commodity suppliers, subassembly suppliers and/or contract manufacturers. Public and/or private individuals or organizations may access the database. For example, regulators, nongovernmental organizations (NGOs), clients, suppliers, original equipment manufacturers (OEMs), distributor or other entities needing to extract material data.

In some embodiments, a user may input either a longitude and latitude of a geographic area, or an address for that geographic area, with the corresponding longitude and latitude being subsequently determined, for example by accessing a longitude and latitude database. If a solar-radiation database is available, it may be accessed to calculate alternative energy-measurement data such as potential-energy production.

Alternatively, the longitude and latitude coordinates of the qualified site may be used to calculate potential-energy production, including determining whether the qualified site is north or south of the equator and distance; identifying the climate (e.g. arid, wet, windy), if rural or city or if there is any relevant obstruction, such as a building or shade. The area of the qualified site may be defined in square meters/miles. The closest construction company for a conversion device may be located. An approximate cost based on location (construction location and square miles) may be determined. If applicable, an estimated return of investment may be determined. Additionally, a local construction company may be notified for construction permits, request for construction bid and/or other information.

While the following alternative embodiments of the invention refer specifically to solar farms, the location of other renewable energy conversion devices may be determined in accordance with the present invention. In some embodiments, a geographic location is entered by a user via a GUI into a database of available funds/grants/ for solar farm development. Dependent upon the geographic location, public or private grants or funds may be searched for and displayed to the user. Those grants or funds may be national, regional or local, and may be available from federal, state, type of business use, type of economic development, tax incentives, etc. Additionally and/or alternatively, potential business partners and/or other interested parties may be displayed.

Radial buttons may be provided on the GUI for the user to choose which of the private or public funds, grants, interested parties, or tax incentives the user wishes to contact and/or apply for. The available relevant data may be automatically entered into the application(s), including for example, the address and location of the local electric grid owners, either larger electric companies or local co-ops. The application(s) may be saved as an electronic file, such as a PDF file, and sent via email to the appropriate address or, if email is unavailable, a physical address may be used, with an option to print out being included.

Once the request for funding and the notification to the right agencies is completed, the associated costs may be calculated. One or more links may be provided to registered local, regional and national solar companies and to registered local, regional and national or residential solar installation contractors. Dependent upon one or more of the type of requested funding, model, contractor, size of the qualified site and type of power grid structure, an approximate cost to build the solar farm may be calculated. Information regarding the local power grid may be accessed to determine the ROI. Additionally and/or alternatively, a business model is drafted for the user.

While the following alternative embodiment of a method for determining the location of a conversion device for converting renewable energy into electrical energy refers specifically to solar farms, the location of other renewable energy conversion devices may be determined in accordance with the present invention. A method and/or system for determining the location of a conversion device to convert renewable energy into electrical energy may include one or more of the following:
receiving a user-identified geographic location for a solar farm;
requesting local contractors' costs and government, academic, grant, and/or credit forms;
collecting location, size, approx type of facility and grid service for the geographic location;
requesting the user to input the data for the grants;
cross referencing the costs using the local contractors labor rates and general material start up costs;
if specific information regarding the geographic location is unavailable, sending a wireless feed to a service provider to update information immediately or to confirm this is the latest information for that geographic location;
available information may be compiled and presented as into a business case that is +/−% of actual;
ROI may be submitted to the user, an interested business or to a government agency;
the user, interested business or agency may approve the ROI;
relevant cost calculations may be revised to reflect approval or disapproval of the ROI;
construction contractors may be notified to meet with the user;
application form(s) for funding may be filled out and submitted automatically to the grant or funding organizations. If immediate submission requires appropriate documentation, the user may be notified. The information may be compiled and presented as it becomes available during construction work;
construction contractor and the user may begin to lay out and plan for the solar farm;
a local utility company may be notified for involvement.

The overabundance of lost farm land and abandoned properties has increased over the past few years. This does not only affect local cities, but townships throughout a government region such as a state. In accordance with some embodiments of the present invention, these properties may be put to use, acquired for tax value or otherwise. Some embodiments may take into account local community electric cooperatives, as well as large consolidated business conglomerates that service multiple communities. Some embodiments may further provide that the properties can be bought by using various local, state, industrial and academic grants or low interest loans to convert these properties into progressive alternative energy locations and offset local and regional utility company grid costs with a quicker return on investment (ROI) and decrease of unused land or building.

By consolidating farmland or city abandoned sites, an electric company or other entity may pay for the costs of acquisition or rent with the savings provided by the alternative energy locations or in conjunction with a grant or federal or private loan. The alternative energy location may be fed back, real-time, into the local grids. The cost to offset the carbon emissions and/or cost to run the nuclear facilities may be offset further by using local land to run the facilities. The savings from use of local land to run the facilities may also pay back the cost of introducing alternative energy locations to electric grids, as well as:
1—Obtain an ROI more quickly, within months instead of years;
2—Increase the use of barren land, land not usable due to land use restrictions, land that may have been decimated, or city locations where buildings have been abandoned or deemed unfit to live; and/or
3—Supply a method and system to develop a closed plan for electric companies to save carbon emissions, with that method and system being more effective than conventional carbon offset methods, providing more effective and attractive land use, and providing assistance to landowners in terms of properties losses or tax liens. These improvements can be obtained by using renewable-energy technology to feed local grids, to pay for use of property, or to pay for tax costs by planning and financing through public or private grants at low costs that produce an ROI of less than a year.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for determining the location of a conversion device for converting renewable energy into electrical energy, via a data processing system, the method comprising:
displaying a qualified site to establish the conversion device within a user-identified geographic area;
calculating the potential energy production of the conversion device at the qualified site;
calculating the cost expenditure to construct the conversion device at the qualified site, the cost expenditure including at least construction contractor labor rates and material costs that are collected from construction contractors located within the geographic area;
displaying for selection by the user at least one public or private funding source to establish the conversion device at the qualified site; and
submitting a funding-source application in response to a user selection of the funding source.

2. The method of claim 1, further comprising:
displaying for user selection at least one construction contractor within the geographic area; and
accepting a user-selected construction contractor.

3. The method of claim 2, further comprising:
contacting the construction contractor in response to the user selection of the construction contractor.

4. The method of claim 1, further comprising:
calculating a projected return of investment of the conversion device at the qualified site.

5. The method of claim 1, further comprising:
displaying more than one qualified site for establishment of a conversion device within a geographic area identified by a user; and
accepting selection of the qualified site by the user.

6. The method of claim 1, further comprising:
requesting data from the user for the funding source application; and
inputting the requested data in the funding source application.

7. The method of claim 1, further comprising:
accepting from an authorized user a new qualified site to establish a conversion device; and
storing the new qualified site.

8. The method of claim 1, further comprising:
accepting a user-selected funding source.

9. A computer program product for determining the location of a conversion device for converting renewable energy into electrical energy, the computer program product comprising:
at least one computer readable storage medium having computer readable program code embodied therewith, the computer readable program code, when read by a processor, configured to:
display a qualified site to establish the conversion device within a user-identified geographic area;
calculate the potential energy production of the conversion device at the qualified site;
calculate the cost expenditure to construct the conversion device at the qualified site, the cost expenditure for construction including at least construction contractor labor rates and material costs collected from construction contractors within the geographic area;
display for user selection at least one public or private funding source to establish the conversion device at the qualified site; and
submit a funding-source application in response to a user selection of the funding source.

10. The computer program product of claim 9, wherein the computer readable program code, when read by a processor, is further configured to:
display for user selection at least one construction contractor within the geographic area;
accept a user-selected construction contractor; and
contact the construction contractor in response to user selection of the construction contractor.

11. The computer program product of claim 9, wherein the computer readable program code, when read by a processor, is further configured to:
calculate a projected return of investment of the conversion device at the qualified site.

12. The computer program product of claim 9, wherein the computer readable program code, when read by a processor, is further configured to:
display more than one qualified site to establish a conversion device within a user-identified geographic area; and
accept a user-selected qualified site.

13. The computer program product of claim 9, wherein the computer readable program code, when read by a processor, is further configured to:
request data from the user for the funding source application; and
input the requested data in the funding source application.

14. A computer system, comprising:
a processor;
a memory; and
a program for determining the location of a conversion device to convert renewable energy into electrical energy, the program including a plurality of instructions stored in the memory that are executed by the processor to:
display a qualified site to establish the conversion device within a user-identified geographic area;
calculate the potential energy production of the conversion device at the qualified site;
calculate the cost expenditure to construct the conversion device at the qualified site, the cost expenditure for construction including at least construction contractor labor rates and material costs collected from construction contractors within the geographic area;
display at least one public or private funding source to establish the conversion device at the qualified site; and
submit a funding-source application in response to a user selection of the funding source.

15. The computer system of claim 14, wherein the plurality of instructions further includes instructions that are executed by the processor to:
display at least one construction contractor within the geographic area;
accept a user-selected construction contractor; and
contact the construction contractor in response to user selection of the construction contractor.

16. The computer system of claim 14, wherein the plurality of instructions further includes instructions that are executed by the processor to:
calculate a projected return of investment of the conversion device at the qualified site.

17. The computer system of claim 14, wherein the plurality of instructions further includes instructions that are executed by the processor to:
display more than one qualified site to establish a conversion device within a user-identified geographic area; and
accept a user-selected qualified site.

18. The computer system of claim 14, wherein the plurality of instructions further includes instructions that are executed by the processor to:
request data from the user for the funding source application; and
input the requested data in the funding-source application.

19. The computer system of claim 14, wherein the plurality of instructions further includes instructions that are executed by the processor to:
accept from an authorized user a new qualified site to establish a conversion device; and
store the new qualified site in the memory.

20. The system of claim 14, wherein the plurality of instructions further includes instructions that are executed by the processor to:
accept selection of a funding source by the user.
